(19) United States
(12) Patent Application Publication
(10) Pub. No.: US 2021/0323141 A1
(43) Pub. Date: Oct. 21, 2021

(54) Protective Key

(71) Applicant: Curv Brands LLC, Elk Grove Village (IL)

(72) Inventor: Michael Tunney, Mount Prospect, IL (US)

(73) Assignee: Curv Brands LLC, Shanghai (CN)

(21) Appl. No.: 16/855,402

(22) Filed: Apr. 22, 2020

Related U.S. Application Data
(63) Continuation-in-part of application No. 29/731,509, filed on Apr. 15, 2020.

(51) Int. Cl. B25J 1/04; F16M 13/04; F16B 45/00; C22C 9/04; A01N 59/16

(52) U.S. Cl. CPC B25J 1/04; F16M 13/04; A01N 59/16; C22C 9/04; F16B 45/00

(57) ABSTRACT

A protective key is provided for placing distance between a user and a touch surface or handle, thereby avoiding direct contact between the user's skin and the touch or grab surface. The protective key helps protect the user from exposure to viruses or bacteria that ay be present on the touch or grab surface, The protective key can be formed of an antimicrobial material that resists accumulation of viruses and bacteria.

This application is a continuation-in-part of U.S. application Ser. No. 29/731,509, filed on 15 Apr. 2020, the disclosure of which is incorporated by reference.

### FIELD OF THE INVENTION

The present invention is directed to a protective key that is useful for protecting a user from a contact surface such as a handle or touch pad, thus avoiding direct contact between the user's skin and bacteria or viruses that may be present on the surface.

### BACKGROUND OF THE INVENTION

The coronavirus pandemic has generated a need or desire for gloves, masks and other protective equipment that prevent direct contact between consumers and various articles that form part of their daily environment. This need or desire is based on concerns that viruses may live for measurable, often extended periods of time on various surfaces. Surfaces that have typically required direct contact with a user's skin include keypads on ATM machines, electronic signature pads, touch pads used for credit card processing, door handles, bus ropes, and various objects. Many of these items require only a pointed touch or pressing, while others require a hooking action of the hand. While protective gloves are commonly used, the gloves themselves may accumulate viruses and bacteria that can be transferred to the user's skin or clothing when the gloves are removed or manipulated. There is a need or desire for a protective device that not only avoids direct skin contact between the user and various surfaces but is formed of an antimicrobial material that resists the accumulation of viruses and bacteria.

### SUMMARY OF THE INVENTION

The present invention is directed to a protective key that can be used to protect a user from direct skin exposure to a contact surface. The contact surface can be a key pad, touch pad, doorbell, button or other surface that requires only a touch or lightly applied pressure from the user, or can be a door handle, bar, lever, bus rope, or bag handle that requires gripping or hooking by the user. The protective key not only places distance between its user and the contact surfaces of interest but can be formed of an antimicrobial material that resists accumulation of viruses and bacteria on the protective key surfaces.

In one embodiment, the protective key includes:

an elongated shaft having a first end, a second end, a first side, a second side, a top surface and a bottom surface;

a handle at the first end of the elongated shaft;

a touch surface at the second end of the elongated shaft;

a hook extending from the bottom surface at the second end of the elongated shaft; and

an abrasive region covering at least a portion of the top surface.

In another embodiment, the protective key includes:

an elongated shaft having a first end, a second end, a first side, a second side, a top surface and a bottom surface;

a handle at the first end of the elongated shaft;

a touch surface at the second end of the elongated shaft; and

a hook extending from the bottom surface at the second end of the elongated shaft;

wherein the protective key comprises an antimicrobial copper-zinc alloy.

In another embodiment, the protective key includes:

an elongated shaft having a first end, a second end, a first side, a second side, a top surface and a bottom surface;

a handle at the first end of the elongated shaft;

a touch surface at the second end of the elongated shaft;

a hook extending from the bottom surface at the second end of the elongated shaft; and

an abrasive region covering at least a portion of the top surface;

wherein the protective key is formed using an antimicrobial alloy comprising about 50% to about 80% by weight copper and about 20% to about 50% by weight zinc.

With the foregoing in mind, it is a feature and advantage of the invention to provide a protective key that maintains distance and avoids skin contact between a user and a surface such as a keypad, credit card processing pad, doorbell, button, and other touch surfaces.

It is also a feature and advantage of the invention to provide a protective key that maintains distance and avoids skin contact between a user and a surface that requires hooking such as a door handle, bar, lever, bus rope, bag handle and other hooked surfaces.

It is also a feature and advantage of the invention to provide a protective key that is formed using an antimicrobial material that resists accumulation of viruses and bacteria.

### BRIEF DESCRIPTION OF THE DRAWINGS

FIG. 1 is a perspective view of the protective key according to one embodiment of the invention.

FIG. 2 is a top view of the protective key of FIG. 1.

FIG. 3 is a bottom view of the protective key of FIG. 1.

FIG. 4 is a front view of the protective key of FIG. 1.

FIG. 5 is a rear view of the protective key of FIG. 1.

FIG. 6 is a left end view of the protective key of FIG. 1.

FIG. 7 is a right end view of the protective key of FIG. 1.

FIG. 8 is a perspective view of the protective key showing one use environment, in which the protective key is attached to a keychain (shown in dotted lines).

### DETAILED DESCRIPTION OF THE INVENTION

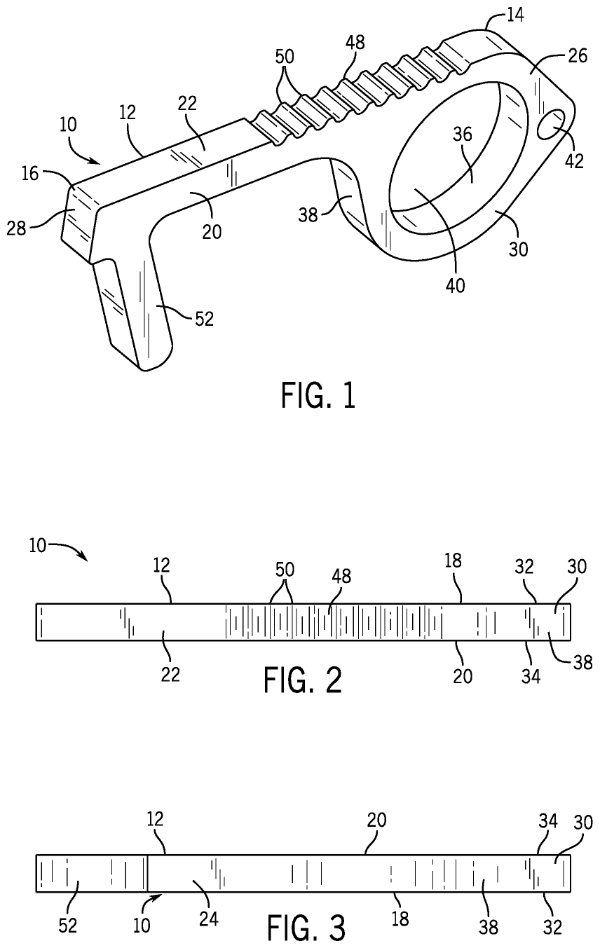

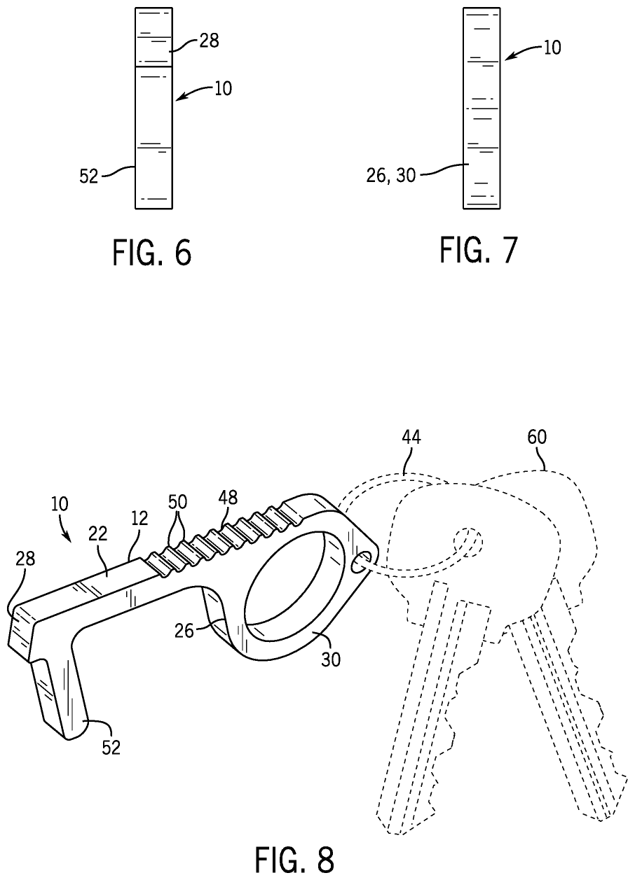

FIGS. 1-8 illustrate of one embodiment of a protective key of the invention, which is designed to protect a user from direct exposure to a contact surface. The protective key 10 includes an elongated shaft 12 having a first end 14, a second end 16, a first side 18, a second side 20, a top surface 22 and a bottom surface 24. A handle 26 is located at the first end 14 of the elongated shaft 12. A touch surface 28 is located at the second end 16 of the elongated shaft 12.

The protective key 10 of the invention is suitably formed using an antimicrobial alloy that resists or prevents accumulation of virus and bacteria on the protective key surfaces. One suitable antimicrobial material is an alloy of copper and zinc. The antimicrobial alloy can include about 50% to about 80% by weight copper and about 20% to about 50% by weight zinc, suitably about 60% to about 70% copper and about 30% to about 40% by weight zinc. Other antimicrobial materials can also be used to form the protective key of the invention.

As best shown in FIGS. 1, 4, 5 and 8, the handle 26 located at the first end 14 of he elongated shaft 12 can be in the form of an extension 30 that protrudes downward from the bottom surface 24 of the elongated shaft 12. The illustrated extension 30 includes a first side 32, a second side 34, an inner wall 36, an outer wall 38, and a handle opening 40 between the first and second sides and defined by the inner wall. The handle opening 40 can be circular as shown in FIGS. 1, 4, 5 and 8, or can be another suitable shape such as semi-circular, oval, rectangular or square, provided that the handle opening 40 is of sufficient size and shape to receive a user's index finger and/or middle finger. The handle 26 can also include a carrier opening 42 defined between the inner wall 36 and the outer wall 38. The carrier opening 42 is smaller than the handle opening 40 and can also be circular, semi-circular, oval, rectangular, square or another shape. The carrier opening 42 has a size and shape sufficient to receive a key carrier such as a keychain ring 44 shown in FIG. 8, or another suitable carrier such as a string, rope, elastic band or chain.

An abrasive region 46 covers at least a portion of the top surface 22 and aids the user in gripping the protective key 10. In one example, the user's middle finger can engage the handle 26 through the handle opening 40 and the user's index finger can engage the abrasive region 48 to help guide the motion of the protective key 10. The abrasive region 48 is suitably close to the first end 14 of the protective key 10 and may cover about 5% to about 100% of the top surface 22, or about 10% to about 75% of the top surface 22, or about 15% to about 60% of he top surface 22, or about 25% to about 50% of the top surface 22. The abrasive region 48 can be formed of a plurality of corrugations 50 in the top surface 22 as shown, or can be formed using any rough, serrated, or textured surface design.

The protective key 10 includes a hook 52 extending downward from the bottom surface 24 of the elongated shaft 12 in the vicinity of the second end 16 and the touch surface 28. The hook 52 can be straight as shown or can be curved and can have a length that is about 15 percent to about 60 percent, suitably about 20 percent to about 50 percent of the overall length of the protective key 10. The reason for making the hook relatively long relative to the protective key 10 is to enable the grabbing of relatively large diameter door handles, levers, bars and the like, as well as relatively narrower bus ropes, bag handles and the like.

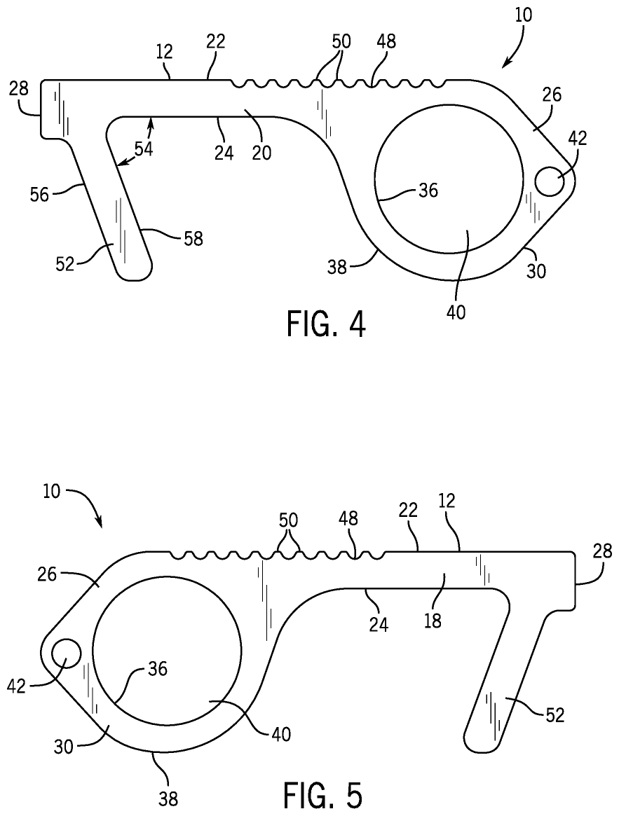

As best shown in FIG. 4, the hook 52 has a forward surface 56 and a rearward surface 58. At least a portion of the rearward surface 58 of the hook 52 can define an angle 54 of about 40 degrees to about 90 degrees, or about 45 degrees to about 85 degrees, or about 50 degrees to about 75 degrees relative to the bottom surface 24 of the elongated shaft 12. This angle enables the user to manipulate the hook 52 to grab and move a door handle, lever, bar, bus rope or bag handle as needed. The stated angle 54 between the rearward surface 58 of the hook 52 and the bottom surface 24 of the elongated shaft 12 need only exist along a portion of the length of the rearward surface 58, for example, if the rearward surface 58 is not straight but is bent or curved. If the rearward surface 58 is straight as illustrated, then the stated angle 54 can exist across substantially the entire length of the rearward surface 58.

The protective key of the invention can have and size depending on the end uses for which it is contemplated. In one embodiment, shown in FIG. 8, the protective key 10 of the invention is sized to fit comfortably on a key ring 44 with or without a plurality of additional keys 60. In another embodiment, the protective key 10 can be sized to fit on a string or rope, suitably an elastic band that can be attached to a user's belt or belt loop. In another embodiment, the protective key 10 can be sized and designed to fit in a Keysmart® pocket key organizer, such as shown in U.S. Design Pat. D705,533 to Tunney, U.S. Design Pat. D754,427 to Tunney, U.S. Pat. D754,428 to Tunney, and/or U.S. Pat. D705,533 to Tunney, each of which is incorporated herein by reference. The protective key 10 of the invention can be sized and designed for a wide variety of uses ranging from small to large, ranging from light touch to heavy pressure, and requiring any degree of strength and integrity.

The embodiments of the invention described herein are exemplary. Various changes and modifications can be made without departing from the spirit and scope of the invention. The scope of the invention is defined by the appended claims, and all changes that fall within the meaning and range of equivalents are intended to be embraced therein.

I claim:

1. A protective key for protecting a user from direct exposure to a contact surface, comprising:
an elongated shaft having a first end, a second end, a first side, a second side, a top surface and a bottom surface;
a handle at the first end of the elongated shaft;
a touch surface at the second end of the elongated shaft;
a hook extending from the bottom surface at the second end of the elongated shaft; and
an abrasive region covering at least a portion of the top surface.

2. The protective key of claim 1, comprising an antimicrobial alloy.

3. The protective key of claim 2, wherein the antimicrobial alloy comprises about 50% to about 80% by weight copper and about 20% to about 50% by weight zinc.

4. The protective key of claim 2, wherein the antimicrobial alloy comprises about 60% to about 70% by weight copper and about 30% to about 40% by weight zinc.

5. The protective key of claim 1, wherein the handle at the first end of the elongated shaft comprises an extension that protrudes downward from the bottom surface of the elongated shaft.

6. The protective key of claim 5, wherein the extension comprises a first side, a second side, an inner wall and an outer wall, and a handle opening between the first and second sides defined by the inner wall.

7. The protective key of claim 1, wherein the hook comprises a forward surface and a rearward surface, and at least a portion of the rearward surface forms an angle of about 40 degrees to about 90 degrees relative to the bottom surface of the elongated shaft.

8. The protective key of claim 7, wherein at least a portion of the rearward surface of the hook forms an angle of about 45 degrees to about 85 degrees relative to the bottom surface of the elongated shaft.

9. The protective ley of claim 1, wherein the abrasive region comprises corrugations in the at least a portion of the top surface.

10. The protective key of claim 6, further comprising a carrier opening defined between the inner wall and the outer wall, the carrier opening being smaller than the handle opening.

11. A protective key for protecting a user from direct exposure to a contact surface, comprising:
an elongated shaft having a first end, a second end, a first side, a second side, a top surface and a bottom surface;
a handle at the first end of the elongated shaft;
a touch surface at the second end of the elongated shaft; and
a hook extending from the bottom surface at the second end of the elongated shaft;
wherein the protective key comprises an antimicrobial copper-zinc alloy.

12. The protective key of claim 11, wherein the antimicrobial alloy comprises about 50% to about 80% by weight copper and about 20% to about 50% by weight zinc.

13. The protective key of claim 11, wherein the antimicrobial alloy comprises about 60% to about 70% by weight copper and about 30% to about 40% by weight zinc.

14. The protective key of claim 11, wherein the handle at the first end of the elongated shaft comprises an extension that protrudes downward from the bottom surface of the elongated shaft, the extension comprising a first side, a second side, an inner wall and an outer wall, and a handle opening between the first and second sides defined by the inner wall.

15. The protective key of claim 11, wherein the hook comprises a forward surface and a rearward surface, and at least a portion of the rearward surface forms an angle of about 40 degrees to about 90 degrees relative to the bottom surface of the elongated shaft.

16. The protective key of claim 11, wherein at least a portion of the rearward surface of the hook forms an angle of about 45 degrees to about 85 degrees relative to the bottom surface of the elongated shaft.

17. The protective key of claim 11, further comprising a corrugated region covering at least a portion of the top surface.

18. A protective key for protecting a user from direct exposure to a contact surface, comprising:
an elongated shaft having a first end, a second end, a first side, a second side, a top surface and a bottom surface;
a handle at the first end of the elongated shaft;
a touch surface at the second end of the elongated shaft;
a hook extending from the bottom surface at the second end of the elongated shaft; and
an abrasive region covering at least a portion of the top surface;
wherein the protective key is formed using an antimicrobial alloy comprising about 50% to about 80% by weight copper and about 20% to about 50% by weight zinc.

19. The protective key of claim 18, wherein the handle comprises a circular handle extending downward from the bottom surface of the elongated shaft.

20. The protective key of claim 18, wherein the hook extends downward from the bottom surface at an angle of about 40 degrees to about 90 degrees relative to the bottom surface.
